(19) United States
(12) Patent Application Publication
(10) Pub. No.: US 2014/0174178 A1
(43) Pub. Date: Jun. 26, 2014

(54) GAIN CONTROL DEVICE OF GYRO SENSOR DRIVING SIGNAL AND GAIN CONTROL METHOD THEREOF

(71) Applicant: SAMSUNG ELECTRO-MECHANICS CO., LTD., SUWON (KR)

(72) Inventors: Seung Chul Pyo, SUWON (KR); Young Kil Choi, Suwon (KR); Jun Kyung Na, Suwon (KR); Sung Tae Kim, Suwon (KR); Chang Hyun Kim, Suwon (KR)

(73) Assignee: SAMSUNG ELECTRO-MECHANICS CO., LTD., SUWON (KR)

(21) Appl. No.: 14/135,367

(22) Filed: Dec. 19, 2013

(30) Foreign Application Priority Data
Dec. 21, 2012 (KR) 10-2012-0151118

(51) Int. Cl. G01C 19/00

(52) U.S. Cl. CPC G01C 19/00
USPC 73/504.02

(57) ABSTRACT

Disclosed herein is a gain control device of a gyro sensor driving signal, including: a gyro sensor generating a gyro signal; a driving signal supply unit applying a driving signal to the gyro sensor; and a gain control unit detecting positive and negative driving signals of the gyro sensor so as to be output as a pulse waveform and changing the pulse waveform to a resistance value corresponding to the pulse waveform to compensate for a gain of the driving signal, whereby it is possible to simply implement the circuit and reduce costs, by controlling the gain of the gyro sensor

### CROSS REFERENCE TO RELATED APPLICATION

This application claims the benefit of Korean Patent Application No. 10-2012-0151118, filed on Dec. 21, 2012, entitled “Gain Control Device Of Gyro Sensor Driving Signal And Gain Control Method Thereof”, which is hereby incorporated by reference in its entirety into this application.

### BACKGROUND OF THE INVENTION

1. Technical Field

The present invention relates to a gain control device of a gyro sensor driving signal and a gain control method thereof

2. Description of the Related Art

An automatic gain control system of a gyro sensor according to the prior art is a type of detecting a signal output from a gyro sensor by various methods to input a value of the detected signal to an ADC and receiving an appropriate control signal value through a digital circuit to control a gain of a driving circuit unit.

For example, in the existing angular velocity circuit, an automatic gain control method detects a signal using a peak detector and applies a signal of the detected signal to the ADC.

Further, the automatic gain control method has a structure of controlling a signal strength by feed-backing an appropriate value programmed by applying the value to the digital controller to the AGC circuit again.

Such a type requires additional circuits for the automatic gain control and therefore has a considerable difficulty in implementing a driving signal control.

[Prior Art Document]

[Patent Document]

(Patent Document 1) U.S. Pat. No. 8,342,026

### SUMMARY OF THE INVENTION

The present invention has been made in an effort to provide a gain control device of a gyro sensor driving signal capable of controlling a gain of the gyro sensor driving signal without using a peak detector and a digital controller, and a gain control method thereof.

According to a preferred embodiment of the present invention, there is provided a gain control device of a gyro sensor driving signal, including: a gyro sensor generating a gyro signal; a driving signal supply unit applying a driving signal to the gyro sensor; and a gain control unit detecting positive and negative driving signals of the gyro sensor so as to be output as a pulse waveform and changing a resistance value of a resistor through which a pulse having the pulse waveform passes to a resistance value corresponding to the pulse waveform to compensate for a gain of the driving signal.

The gain control unit may include: a driving signal detector detecting the positive and negative driving signals of the gyro sensor; a differential amplifier amplifying a difference between the positive and negative driving signals which are detected by the driving signal detector; a comparator having a non-inversion terminal to which a signal representing the difference in the positive and negative driving signals amplified by the differential amplifier is input and an inversion terminal to which a set reference signal is input and comparing a magnitude of the signal representing the difference in the driving signals with a magnitude of the reference signal so as to be output as the pulse waveform; and a gain compensator changing the resistance value of the resistor through which the pulse having the pulse waveform output by the comparator passes to the resistance value corresponding to the pulse waveform to compensate for the gain of the driving signal.

The gain compensator may change the resistance value of the resistor to a resistance value corresponding to a duty ratio of the pulse waveform.

The gain compensator may change the resistance value of the resistor to the resistance value corresponding to the duty ratio of the pulse waveform, based on a look-up table in which the duty ratio of the pulse waveform and the resistance value depending on the duty ratio are written.

The duty ratio of the pulse waveform and the resistance value corresponding to the pulse waveform may have a linear relationship.

The relationship of the resistance value corresponding to the pulse waveform to the duty ratio of the pulse waveform may have a positive slope.

The comparator may modulate and output a pulse width of the pulse waveform so that a magnitude difference between a signal representing a difference in the driving signals and the reference signal has a set value.

According to another preferred embodiment of the present invention, there is provided a gain control method of a gyro sensor driving signal, including: (A) applying, by a driving signal supply unit, a driving signal to a gyro sensor; (B) detecting, by a gain control unit, positive and negative driving signals of the gyro sensor so as to be output as a pulse waveform; and (C) changing, by the gain control unit, a resistance value of a resistor through which the pulse having the pulse waveform passes to a resistance value corresponding to the pulse waveform to compensate for a gain of the driving signal.

The step (B) may include (B1) detecting, by a driving signal detector, the positive and negative driving signals of the gyro sensor; (B2) amplifying, by a differential amplifier, a difference between the positive and negative driving signals which are detected by the driving signal detector; (B3) inputting a signal representing the difference in the positive and negative driving signals amplified by the differential amplifier to a non-inversion terminal of a comparator and inputting a set reference signal to an inversion terminal thereof; and (B4) comparing, by the comparator, a magnitude of the signal representing the difference in the driving signals with a magnitude of the reference signal so as to be output as the pulse waveform.

In the step (B4), the resistance value of the resistor may change to a resistance value corresponding to a duty ratio of the pulse waveform.

In the step (B4), the resistance value of the resistor may change to the resistance value corresponding to the duty ratio of the pulse waveform, based on a look-up table in which the duty ratio of the pulse waveform and the resistance value depending on the duty ratio are written.

The duty ratio of the pulse waveform and the resistance value corresponding to the pulse waveform may have a linear relationship.

A relationship of the resistance value corresponding to the pulse waveform to the duty ratio of the pulse waveform may have a positive slope.

The comparator may modulate and output a pulse width of the pulse waveform so that a magnitude difference between the signal representing a difference in the driving signals and the reference signal has a set value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a gain control device of a gyro sensor driving signal according to a preferred embodiment of the present invention;

FIG. 2 is a circuit diagram of the gain control device of a gyro sensor driving signal according to the preferred embodiment of the present invention;

FIG. 3 is a detailed block diagram of a gain control unit of FIG. 1;

FIG. 4 is a detailed circuit diagram of FIG. 2;

FIG. 5 is a graph illustrating a relationship of a resistance value of a pulse waveform to a duty ratio of the pulse waveform according to the preferred embodiment of the present invention; and

FIG. 6 is a flow chart of a gain control method of a gyro sensor driving signal according to a preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

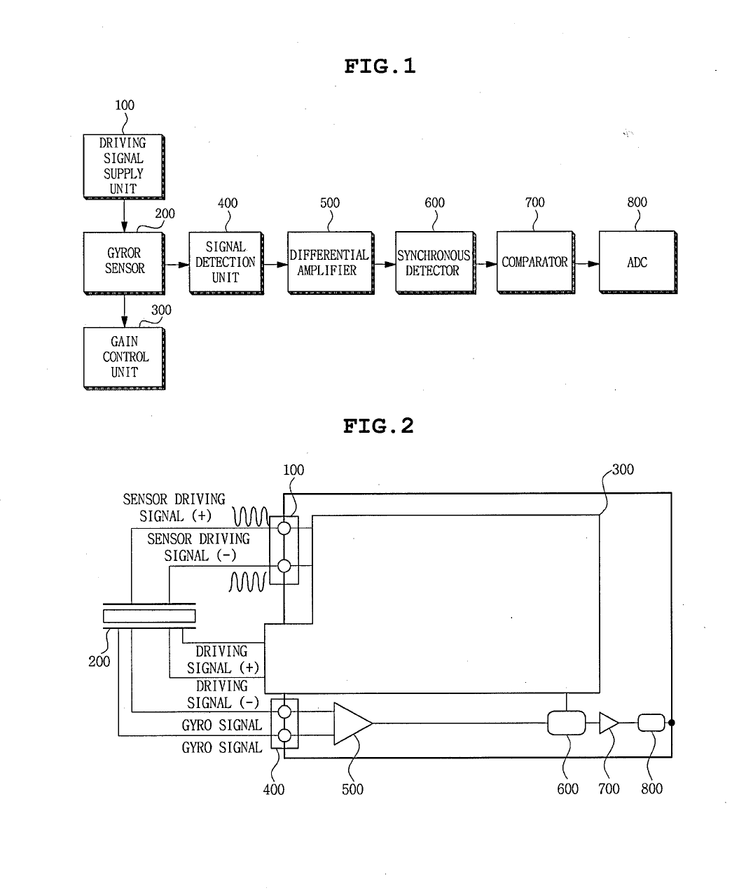

FIG. 1 is a block diagram of a gain control device of a gyro sensor driving signal according to a preferred embodiment of the present invention and FIG. 2 is a circuit diagram of the gain control device of a gyro sensor driving signal according to the preferred embodiment of the present invention. Referring to FIGS. 1 and 2, the gain control device of a gyro sensor driving signal may include a driving signal supply unit 100, a gyro sensor 200, a gain control unit 300, and a signal detection unit 400.

The driving signal supply unit 100 applies a driving signal to the gyro sensor 200.

The gyro sensor 200 is referred to as a gyroscope and generates a gyro signal using an angular velocity sensor which detects an angular velocity (rotating speed). The gyro sensor 200 is a sensor which represents a value of a rotating angle of an object based on one shaft in a unit time by a numerical value. For example, since the gyro sensor 200 informs a rotating angle of a robot when the robot rotates, the gyro sensor 200 is mainly used in a navigation device.

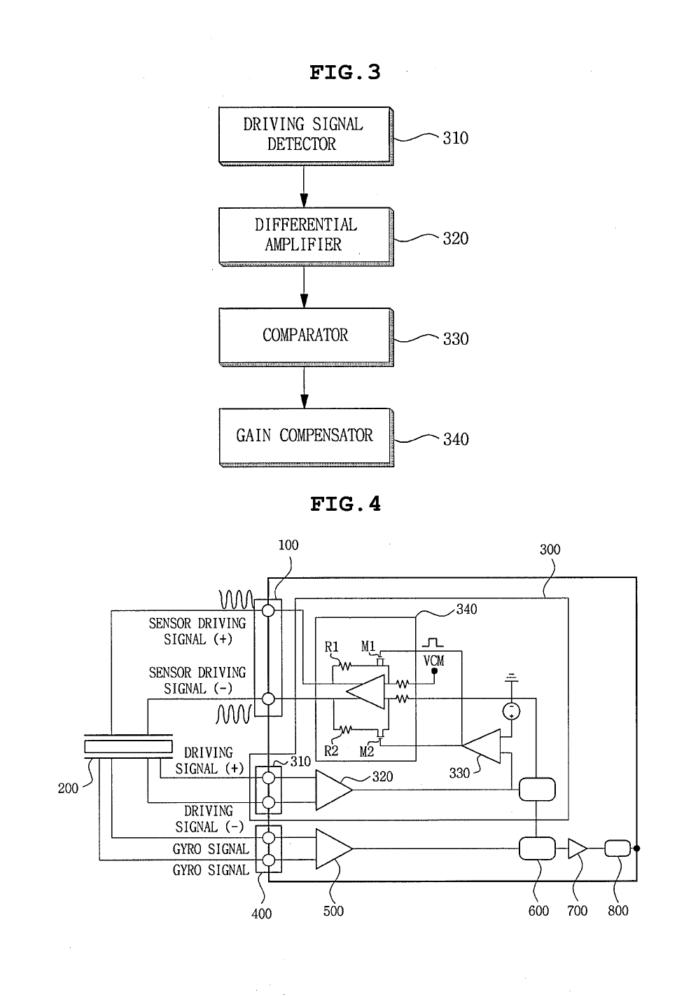

The gain control unit 300 detects positive and negative driving signals of the gyro sensor 200 and outputs the detected driving signals as a pulse waveform and changes a resistance value of a resistor through which a pulse having the pulse waveform passes to a resistance value corresponding to the pulse waveform so as to compensate for the gain of the driving signals. The detailed configuration of the gain control unit 300 will be described with reference to FIG. 3.

The signal detection unit 400 detects the gyro signal which is generated by the gyro sensor 200. Two gyro signals which are detected by the signal detection unit 400 are input to a differential amplifier 500 which amplifies a difference between the two gyro signals, in which the amplified signal is input to a synchronous detector 600. The synchronous detector 600 receives a phase moving signal from the gain control unit 300 and detects a synchronous signal from the amplified signal. The signal detected by the synchronous detector 600 is input to an ADC 800 via a comparator 700.

FIG. 3 is a detailed block diagram of the gain control unit of FIG. 1 and FIG. 4 is a detailed circuit diagram of FIG. 2. Referring to FIGS. 3 and 4, the gain control unit 300 may include a driving signal detector 310, a differential amplifier 320, a comparator 330, and a gain compensator 340.

The driving signal detector 310 detects the positive and negative driving signals of the gyro sensor 200.

The differential amplifier 320 amplifies a difference between the positive and negative driving signals which are detected by the driving signal detector 310.

The comparator 330 has a non-inversion terminal to which the signal representing the difference between the positive and negative driving signals amplified by the differential amplifier 320 is input and an inversion terminal to which a set reference signal is input and compares a magnitude of the signal representing the difference between the driving signals with a magnitude of a reference signal so as to be output as the pulse waveform. The comparator 330 modulates and outputs a pulse width of the pulse waveform so that the magnitude difference between the signal representing the difference between the driving signals and the reference signal has a set value. That is, when the magnitude difference between the signal representing the difference between the driving signals and the reference signal is larger than the set value, the comparator 330 modulates and outputs the pulse width of the pulse waveform so as to reduce the magnitude difference. However, when the magnitude difference between the signal representing the difference between the driving signals and the reference signal is smaller than the set value, the comparator 330 modulates and outputs the pulse width of the pulse waveform so as to increase the magnitude difference.

The gain compensator 340 changes the resistance value of the resistor through which the pulse having the pulse waveform output by the comparator 330 to a resistance value corresponding to a duty ratio of the pulse waveform so as to compensate for the gain of the driving signal. In detail, the gain compensator 340 changes the resistance value of the resistor to the resistance value corresponding to the duty ratio of the pulse waveform, based on a look-up table in which the duty ratio of the pulse waveform and the resistance value depending on the duty ratio are written. That is, the gain compensator 340 includes a first MOSFET M1 and a second MOSFET M2 which receive the pulse waveform to perform a switching operation and a first resistor R1 and a second resistor R2 which vary depending on the switching operations of the first MOSFET M1 and the second MOSFET M2. In this case, the duty ratio of the pulse waveform and the resistance value corresponding to the pulse waveform have a linear relationship, in which a relationship of the resistance value corresponding to the pulse waveform to the duty ratio of the pulse waveform has a positive slope.

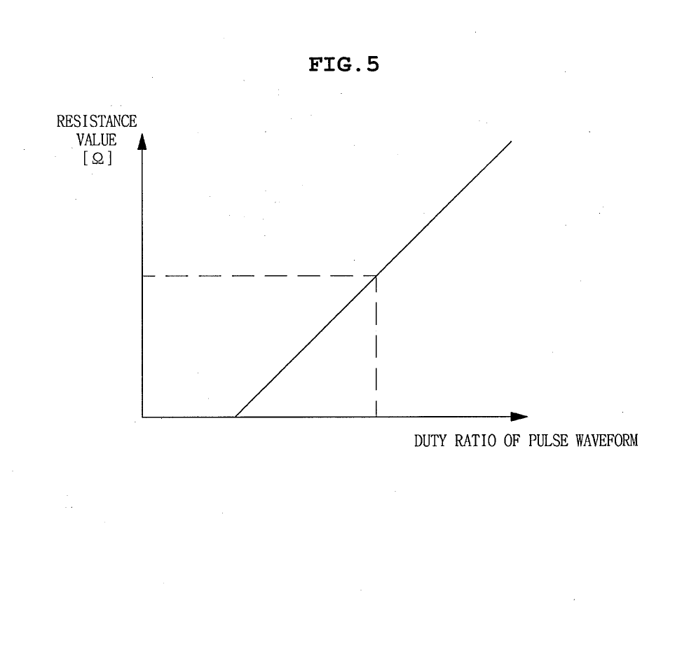

FIG. 5 is a graph illustrating a relationship of the resistance value corresponding to the pulse waveform to the duty ratio of the pulse waveform according to the preferred embodiment of the present invention. Referring to FIG. 5, the resistance value corresponding to the pulse waveform to the duty ratio of the pulse waveform according to the preferred embodiment of the present invention has the linear relationship. That is, as the duty ratio of the pulse waveform is increased, the resistance value corresponding to the pulse waveform is increased. Referring to FIG. 4, the first MOSFET M1 and the second MOSFET M2 perform the switching operation by receiving the pulse waveform to change the resistance values of the first resistor R1 and the second resistor R2 and as the duty ratios of the pulse waveforms input to the first MOSFET Ml and the second MOSFET M2 are increased, the resistance values of the first resistor R1 and the second resistor R2 are linearly increased.

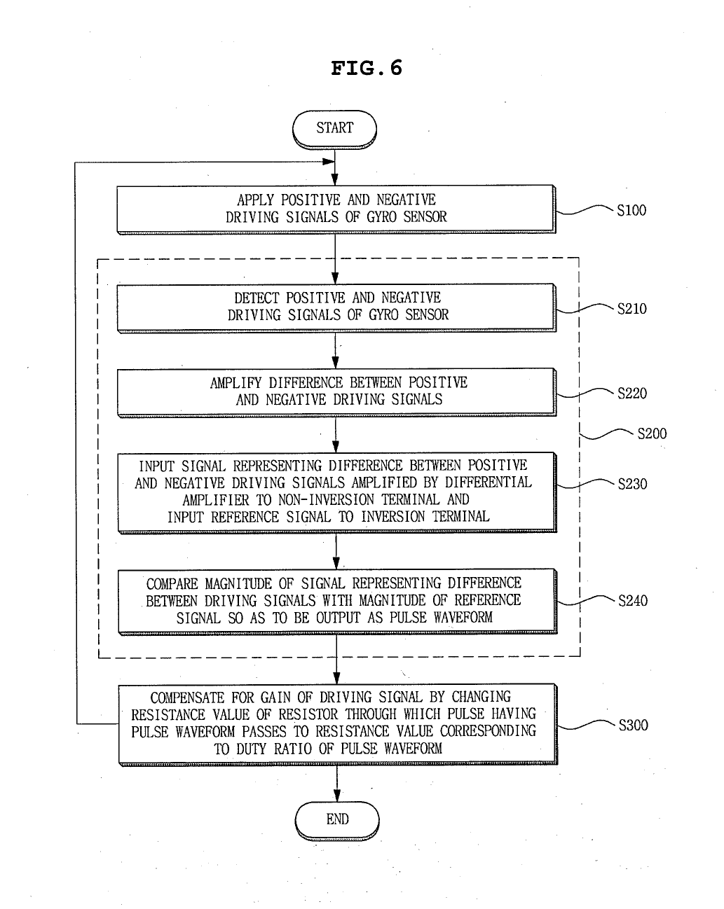

FIG. 6 is a flow chart of a gain control method of a gyro sensor driving signal according to a preferred embodiment of the present invention. Referring to FIG. 6, the gain control method of a gyro sensor driving signal according to the preferred embodiment of the present invention includes steps S100 to S300, in which step S200 may include steps S210 to S240.

First, the driving signal supply unit 100 applies the driving signal to the gyro sensor 200 (S100).

After step S100, the gain control unit 300 detects the positive and negative driving signals of the gyro sensor 200 so as to be output as the pulse waveform (S200).

Describing in detail step S200, the step S200 includes steps S210 to S240.

First, the driving signal detector 310 detects the positive and negative driving signals of the gyro sensor 200 (S210).

After the step S210, the differential amplifier 320 amplifies the difference between the positive and negative driving signals which are detected by the driving signal detector 310 (S220).

After the step S220, the comparator 330 has the non-inversion terminal to which the signal representing the difference between the positive and negative driving signals amplified by the differential amplifier 320 is input and the inversion terminal to which the set reference signal is input (S230). That is, when the magnitude difference between the signal representing the difference between the driving signals and the reference signal is larger than the set value, the comparator 330 modulates and outputs the pulse width of the pulse waveform so as to reduce the magnitude difference. However, when the magnitude difference between the signal representing the difference between the driving signals and the reference signal is smaller than the set value, the comparator 330 modulates and outputs the pulse width of the pulse waveform so as to increase the magnitude difference.

After the step S230, the comparator 330 compares the magnitude of the signal representing the difference between the driving signals with the magnitude of the reference signal so as to be output as the pulse waveform (S240). The comparator 330 modulates and outputs the pulse width of the pulse waveform so that the magnitude difference between the signal representing the difference between the driving signals and the reference signal has the set value. That is, when the magnitude difference between the signal representing the difference between the driving signals and the reference signal is larger than the set value, the comparator 330 modulates and outputs the pulse width of the pulse waveform so as to reduce the magnitude difference. However, when the magnitude difference between the signal representing the difference between the driving signals and the reference signal is smaller than the set value, the comparator 330 modulates and outputs the pulse width of the pulse waveform so as to increase the magnitude difference.

After the step S200, the gain control unit 300 changes the pulse waveform to the resistance value corresponding to the duty ratio of the pulse waveform so as to compensate for the gain of the driving signal (S300). Describing in detail step S300, the gain compensator 340 changes the pulse waveform to the resistance value corresponding to the duty ratio of the pulse waveform, based on the look-up table in which the duty ratio of the pulse waveform and the resistance value depending on the duty ratio are written. That is, the gain compensator 340 includes the first MOSFET Ml and the second MOSFET M2 which receive the pulse waveform to perform the switching operation and the first resistor R1 and the second resistor R2 which vary depending on the switching operations of the first MOSFET M1 and the second MOSFET M2. In this case, the duty ratio of the pulse waveform and the resistance value corresponding to the pulse waveform have the linear relationship, in which the relationship of the resistance value corresponding to the pulse waveform to the duty ratio of the pulse waveform has the positive slope.

After step S300, the process returns to step S100 for the driving signal supply unit 100 to apply the driving signal compensated by the gain control unit 300 to the gyro sensor 200 to repeatedly perform the following process.

In connection with the gain control device of a gyro sensor driving signal and the gain control method thereof according to the preferred embodiments of the present invention, the prior art requires many circuits, such as a signal comparison unit, a pulse width modulation control unit, a differential operation amplifier, and a high voltage conversion unit for automatic gain control and has a considerable difficulty in implementing the driving signal control. However, according to the preferred embodiments of the present invention, it is possible to simply implement the circuit and reduce costs, by controlling the gain of the gyro sensor driving signal without the peak detector and the digital controller.

According to the preferred embodiments of the present invention, it is possible to simply implement the circuit and reduce costs, by controlling the gain of the gyro sensor driving signal without the peak detector and the digital controller.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A gain control device of a gyro sensor driving signal, comprising:
a gyro sensor generating a gyro signal;
a driving signal supply unit applying a driving signal to the gyro sensor; and
a gain control unit detecting positive and negative driving signals of the gyro sensor so as to be output as a pulse waveform and changing a resistance value of a resistor through which a pulse having the pulse waveform passes to a resistance value corresponding to the pulse waveform to compensate for a gain of the driving signal.

2. The gain control device as set forth in claim 1, wherein the gain control unit includes:
a driving signal detector detecting the positive and negative driving signals of the gyro sensor;
a differential amplifier amplifying a difference between the positive and negative driving signals which are detected by the driving signal detector;
a comparator having a non-inversion terminal to which a signal representing the difference between the positive and negative driving signals amplified by the differential amplifier is input and an inversion terminal to which a set reference signal is input and comparing a magnitude of the signal representing the difference between the driving signals with a magnitude of the reference signal so as to be output as the pulse waveform; and
a gain compensator changing the resistance value of the resistor through which the pulse having the pulse waveform output by the comparator passes to the resistance value corresponding to the pulse waveform to compensate for the gain of the driving signal.

3. The gain control device of claim 2, wherein the gain compensator changes the resistance value of the resistor to a resistance value corresponding to a duty ratio of the pulse waveform.

4. The gain control device as set forth in claim 3, wherein the gain compensator changes the resistance value of the resistor to the resistance value corresponding to the duty ratio of the pulse waveform, based on a look-up table in which the duty ratio of the pulse waveform and the resistance value depending on the duty ratio are written.

5. The gain control device as set forth in claim 2, wherein the duty ratio of the pulse waveform and the resistance value corresponding to the pulse waveform have a linear relationship.

6. The gain control device as set forth in claim 5, wherein the relationship of the resistance value corresponding to the pulse waveform to the duty ratio of the pulse waveform has a positive slope.

7. The gain control device as set forth in claim 2, wherein the comparator modulates and outputs a pulse width of the pulse waveform so that a magnitude difference between a signal representing a difference in the driving signals and the reference signal has a set value.

8. A gain control method of a gyro sensor driving signal, comprising:
(A) applying, by a driving signal supply unit, a driving signal to a gyro sensor;
(B) detecting, by a gain control unit, positive and negative driving signals of the gyro sensor so as to be output as a pulse waveform; and
(C) changing, by the gain control unit, a resistance value of a resistor through which the pulse having the pulse waveform passes to a resistance value corresponding to the pulse waveform to compensate for a gain of the driving signal.

9. The gain control device as set forth in claim 8, wherein the step (B) includes:
(B1) detecting, by a driving signal detector, the positive and negative driving signals of the gyro sensor;
(B2) amplifying, by a differential amplifier, a difference between the positive and negative driving signals which are detected by the driving signal detector;
(B3) inputting a signal representing the difference between the positive and negative driving signals amplified by the differential amplifier to a non-inversion terminal of a comparator and inputting a set reference signal to an inversion terminal thereof; and
(B4) comparing, by the comparator, a magnitude of the signal representing the difference between the driving signals with a magnitude of the reference signal so as to be output as the pulse waveform.

10. The gain control method as set forth in claim 9, wherein in the step (B4), the resistance value of the resistor changes to a resistance value corresponding to a duty ratio of the pulse waveform.

11. The gain control method as set forth in claim 10, wherein in the step (B4), the resistance value of the resistor changes to the resistance value corresponding to the duty ratio of the pulse waveform, based on a look-up table in which the duty ratio of the pulse waveform and the resistance value depending on the duty ratio are written.

12. The gain control method as set forth in claim 9, wherein the duty ratio of the pulse waveform and the resistance value corresponding to the pulse waveform have a linear relationship.

13. The gain control method as set forth in claim 12, wherein a relationship of the resistance value corresponding to the pulse waveform to the duty ratio of the pulse waveform has a positive slope.

14. The gain control method as set forth in claim 9, wherein the comparator modulates and outputs a pulse width of the pulse waveform so that a magnitude difference between the signal representing a difference in the driving signals and the reference signal has a set value.
